(19) United States
(12) Patent Application Publication
(10) Pub. No.: US 2024/0183677 A1
(43) Pub. Date: Jun. 6, 2024

(54) PEOPLE-FLOW ANALYSIS APPARATUS, PEOPLE-FLOW ANALYSIS METHOD, AND PEOPLE-FLOW ANALYSIS SYSTEM

(71) Applicant: PACIFIC CONSULTANTS CO., LTD., Tokyo (JP)

(72) Inventors: Nobuyuki SUGIMOTO, Tokyo (JP); Daisuke KANEKI, Tokyo (JP); Atsushi UENO, Sendai (JP)

(73) Assignee: PACIFIC CONSULTANTS CO., LTD., Tokyo (JP)

(21) Appl. No.: 18/431,057

(22) Filed: Feb. 2, 2024

Related U.S. Application Data
(63) Continuation of application No. PCT/JP2022/030207, filed on Aug. 8, 2022.

(30) Foreign Application Priority Data
Aug. 12, 2021 (JP) 2021-131773

(51) Int. Cl. G01C 21/34; G06Q 50/40

(52) U.S. Cl. CPC G01C 21/3492; G06Q 50/40

(57) ABSTRACT

An apparatus incudes processing circuitry configured to: read, along with time information, location information included in radio waves received by a positioning apparatus from multiple mobile terminals; perform cleansing processing for thinning out, according to a predetermined rule, the location information received by the positioning apparatus; generate, for the cleansed location information, trip data indicating travel paths of users carrying the mobile terminals; and determine, for the generated trip data, means of transportation of the users.

### CROSS-REFERENCE TO RELATED APPLICATION

This application is based upon and claims the benefit of priority from the prior Japanese Patent Application (s) No. 2021-131773, filed Aug. 12, 2021 and from PCT Patent Application No. PCT/JP2022/030207, the entire contents of all of which are incorporated herein by reference.

### FIELD

Embodiments described herein relate generally to a people-flow analysis apparatus, a people-flow analysis method, and a people-flow analysis system.

### BACKGROUND

Systems have been known that compute a people-flow distribution by inputting, to a people-flow model, actual observed values of flows of people in a predetermined area.

As such a system, a conventional people-flow distribution delivery system having a function of delivering people-flow distribution data estimating a people-flow distribution from hypothetical data of the people-flow distribution is disclosed.

Unfortunately, conventional systems as above may compute inaccurate values of the people-flow distribution if the people-flow model obtained from the hypothetical data on the people-flow distribution is inappropriate.

An object of the present invention is to provide a people-flow analysis system capable of analyzing highly accurate people-flow data by aggregating a history of actual observed location information.

### BRIEF DESCRIPTION OF THE DRAWINGS

FIG. 1 is a block diagram illustrating a configuration of a people-flow analysis system 1 in an embodiment.

FIG. 2 is a block diagram illustrating a configuration of a user terminal 10 in the embodiment.

FIG. 3 is a block diagram illustrating a configuration of an information processing server 20 in the embodiment.

FIG. 4A is a diagram for describing an overview of the embodiment.

FIG. 4B is a diagram for describing an overview of the embodiment.

FIG. 5 is a diagram illustrating an overview of cleansing processing.

FIG. 6 is a diagram for describing generation of trip data.

FIG. 7 is a diagram for describing an overview of determination of means of transportation.

FIG. 8 is a diagram for describing processing performed if the means of transportation is determined to be aircraft in the determination of the means of transportation.

FIG. 9 is a diagram for describing processing performed if the means of transportation is determined to be railway or expressway in the determination of the means of transportation.

FIG. 10 is a diagram for describing scale-up processing.

FIG. 11 is a flowchart illustrating a general process in the people-flow analysis system.

FIG. 12 is a flowchart illustrating processing of obtaining location information.

FIG. 13 is a flowchart illustrating the cleansing processing.

FIG. 14 is a flowchart illustrating processing of the trip data.

FIG. 15 is a flowchart illustrating processing of determining the means of transportation.

FIG. 16 is a flowchart illustrating processing of calculating scale-up factors.

FIG. 17 is a flowchart illustrating the scale-up processing.

FIG. 18 is a diagram illustrating a variation of a positioning apparatus.

### DETAILED DESCRIPTION

In general, according to one embodiment, an apparatus of the present invention is a people-flow analysis apparatus that analyzes people-flow data using location information from mobile terminals, the apparatus comprises processing circuitry configured to: read, along with time information, location information included in radio waves received by a positioning apparatus from multiple mobile terminals; perform cleansing processing for thinning out, according to a predetermined rule, the location information received by the positioning apparatus; generate, for the cleansed location information, trip data indicating travel paths of users carrying the mobile terminals; and determine, for the generated trip data, means of transportation of the users.

An embodiment of the present invention will be described in detail below with reference to the drawings. Throughout the drawings for describing the embodiment, like elements are basically labeled with like symbols, and description of these elements will not be repeated.

### (1) Configuration of People-Flow Analysis System 1

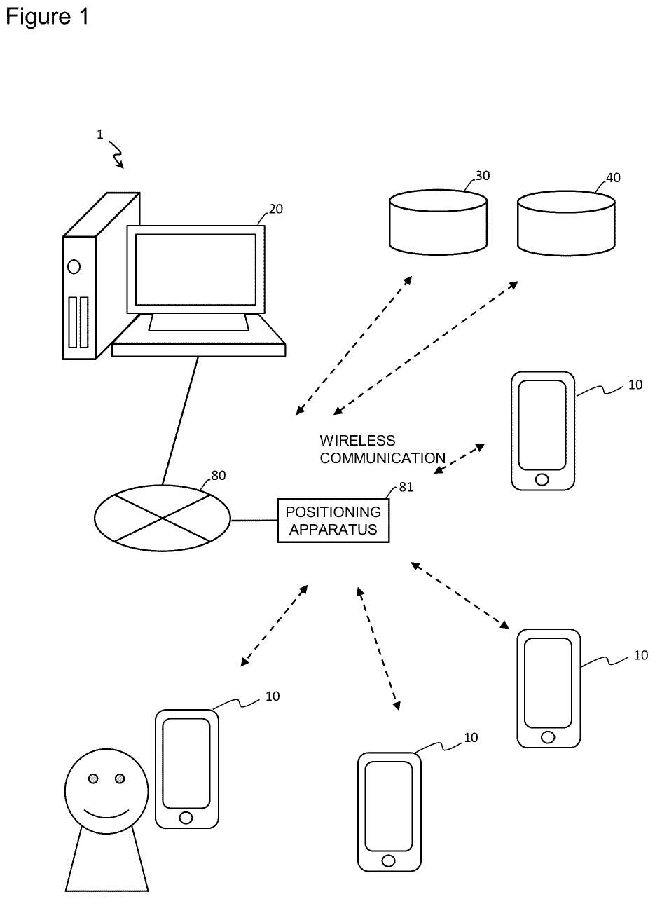

A configuration of a people-flow analysis system 1 will be described. FIG. 1 is a block diagram illustrating the configuration of the people-flow analysis system 1 in this embodiment.

As illustrated in FIG. 1, the people-flow analysis system 1 includes user terminals 10 and an information processing server 20.

The user terminals 10 and the information processing server 20 are connected via a network (e.g., the Internet or an intranet) 80.

The user terminals 10 and the information processing server 20 are connected to a traffic network database 30 and a demographic database 40 via the network 80.

The user terminals 10 are information processing apparatuses, such as mobile phones, carried by users. The user terminals 10 are configured to wirelessly communicate with a positioning apparatus 81. The user terminals 10 are communication apparatuses that travel while being carried by the users, and may also be referred to as mobile terminals. In addition to mobile phones, such mobile terminals include Wi-Fi beacons used while being carried by users, mobile antennas used for radar positioning, in-vehicle car navigation terminals that support ITS spots (DSRC), and communication terminals that use Bluetooth I. The mobile terminals may also be other terminals that communicate while travelling.

The positioning apparatus 81 is an apparatus that communicates with communication apparatuses. It includes a base station for mobile phones, as well as a positioning apparatus that communicates with, e.g., Wi-Fi beacons, a positioning apparatus that performs radar positioning, and a positioning apparatus at an ITS spot. The positioning apparatus 81 may be a fixed positioning apparatus that communicates with communication apparatuses while being fixed to a predetermined location, or may be a mobile positioning apparatus, as in a GPS system to be described later, that communicates with communication apparatuses while moving.

The user terminals 10, which are apparatuses wirelessly communicating with the positioning apparatus 81, may include various computers, for example smartphones, tablet terminals, and wearable devices (e.g., smart watches and smart glasses). As an example, this embodiment describes the user terminals 10 as smartphones that wirelessly communicate with base stations (the positioning apparatus 81) of mobile phones having antennas used for wireless communication of the mobile phones.

The information processing server 20 is an information processing apparatus that subjects input information to various sorts of processing for people-flow analysis to be described later. The information processing server 20 performs processing of analyzing location information on the user terminals 10 obtained based on wireless communication of the user terminals 10 with the positioning apparatus 81.

The information processing server 20 may include various computers, such as a personal computer and a server computer (e.g., a web server, an application server, a database server, or a combination thereof). As an example, this embodiment describes the information processing server 20 as a personal computer that processes the location information obtained from the positioning apparatus 81.

The traffic network database 30 is a database storing information on means of transportation, such as railways, expressways, and aircraft. The traffic network database 30 stores, as information on traffic base points, information such as the facility name, facility number, and location of each traffic base point, the names of routes connecting each traffic base point, information on operation schedules of transportation between base points, and information on fares. A traffic base point is a facility used as a start or a goal for means of transportation, such as an airport, a station, or an expressway interchange.

The traffic network database 30 also stores information on the statistical numbers of users of the means of transportation.

The demographic database 40 is a database storing the numbers of residents on a regional basis. For example, the demographic database 40 stores a population of each of mesh areas (partitioned areas) resulting from partitioning the land of Japan into predetermined areas. Each mesh area is assigned a mesh code that identifies the area. For an underpopulated region such as a mountainous region, where not many residents live, a larger area integrating mesh areas is defined as an integrated mesh, which is assigned an integrated mesh code that identifies the integrated mesh.

### (1-1) Configuration of User Terminal 10

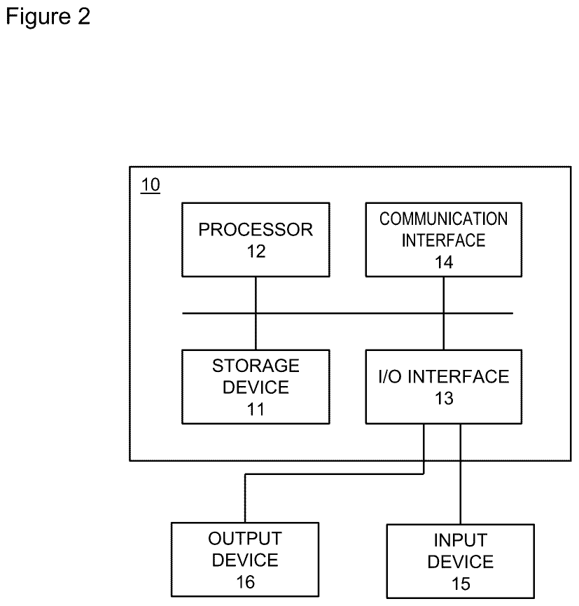

A configuration of the user terminals 10 will be described. FIG. 2 is a block diagram illustrating the configuration of the user terminal 10 in this embodiment.

As illustrated in FIG. 2, the user terminal 10 includes a storage device 11, a processor 12, an I/O interface 13, and a communication interface 14. The user terminal 10 can be connected to at least one of an input device 15 and an output device 16.

The storage device 11 is configured to store programs and data. The storage device 11 is, for example, a combination of a read only memory (ROM), a random access memory (RAM), and a storage (e.g., flash memory or a hard disk).

Examples of the programs include the following.
programs of an operating system (OS)
programs of applications (e.g., a web browser) that perform information processing Examples of the data include the following.
databases referred to in information processing
data obtained by performing information processing (i.e., results of performing information processing)

The processor 12 is configured to launch programs stored in the storage device 11 to implement functions of the user terminal 10. The processor 12 is an example of a computer.

The I/O interface 13 is configured to obtain signals (e.g., user instructions, sensing signals, or combinations thereof) from the input device 15, and to output signals (e.g., image signals, sound signals, or combinations thereof) to the output device 16.

The input device 15 is, for example, a keyboard, a pointing device, a touch panel, a physical button, a sensor (e.g., a camera, a vital sensor, or a combination thereof), or a combination thereof.

The output device 16 is, for example, a display, a speaker, a printer, or a combination thereof.

The communication interface 14 is configured to control communication between the user terminal 10 and external apparatuses.

### (1-2) Configuration of Information Processing Server 20

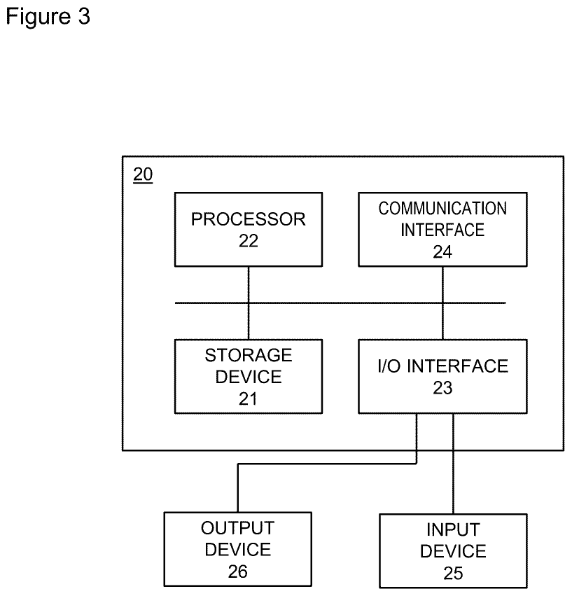

A configuration of the information processing server 20 will be described. FIG. 3 is a block diagram illustrating the configuration of the information processing server 20 in this embodiment.

As illustrated in FIG. 3, the information processing server 20 includes a storage device 21, a processor 22, an I/O interface 23, and a communication interface 24. The information processing server 20 can be connected to at least one of an input device 25 and an output device 26.

The storage device 21 is configured to store programs and data. The storage device 21 is, for example, a combination of a ROM, a RAM, and a storage (e.g., flash memory or a hard disk).

Examples of the programs include the following.
programs of an operating system (OS)
programs of applications that perform information processing

Examples of the data include the following.
databases referred to in information processing
results of performing information processing

The processor 22 is configured to launch programs stored in the storage device 21 to implement functions of the information processing server 20. The processor 22 is an example of a computer.

The I/O interface 23 is configured to obtain signals (e.g., user instructions, sensing signals, or combinations thereof) from the input device 25, and to output signals (e.g., image signals, sound signals, or combinations thereof) to the output device 26.

The input device 25 is, for example, a keyboard, a pointing device, a touch panel, a sensor, or a combination thereof.

The output device 26 is, for example, a display, a speaker, or a combination thereof.

The communication interface 24 is configured to control communication between the information processing server 20 and external apparatuses.

### (2) Overview of Embodiment

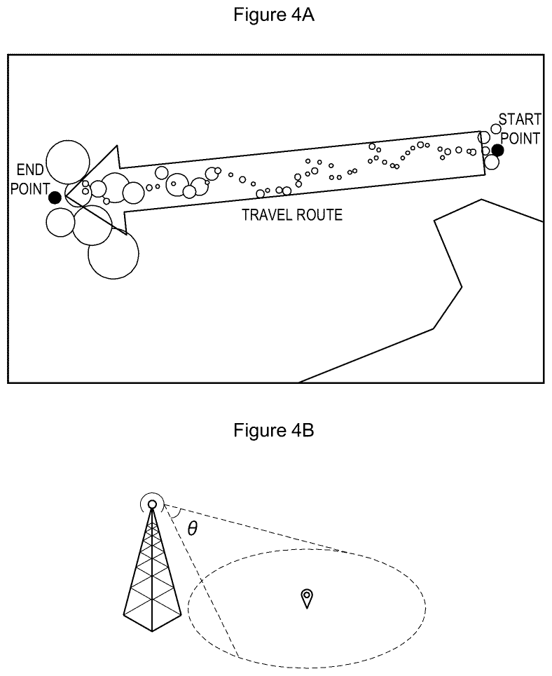

An overview of the people-flow analysis system 1 according to this embodiment will be described. FIGS. 4A and 4B are diagrams for describing an overview of this embodiment. In the figure, FIG. 4A is a diagram for describing an overview of analysis processing performed by the people-flow analysis system 1.

As illustrated in FIG. 4A, the people-flow analysis system 1 utilizes wireless communication between the user terminal 10 and the positioning apparatus 81 to obtain, by estimation, location information on the user terminal 10 over time in a large area and analyze the flows of people.

FIG. 4B is a diagram illustrating the location information obtained by the positioning apparatus 81 from the user terminal 10. As illustrated in FIG. 4B, the positioning apparatus 81 covers communication within a predetermined communication area. When the user terminal 10 is located in the communication area in which the positioning apparatus 81 is capable of communication, the positioning apparatus 81 accumulates, in a location information database and along with time information, location information estimated from radio waves received from the user terminal 10. The location information database is a database operated by a mobile phone carrier, in which the location information obtained by the positioning apparatus 81, along with the time information, is accumulated for individual terminals being used.

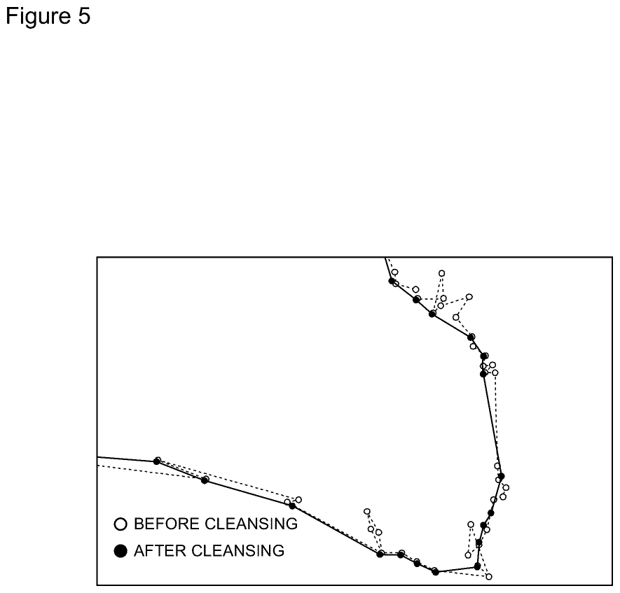

The people-flow analysis system 1 reads the location information on the user terminal 10 from the location information database and chronologically sorts the information according to the time information indicating the time of obtainment of the information. The people-flow analysis system 1 thus generates a travel path of the user terminal 10 to determine start and goal points of the travel path, and a travel route. Here, the people-flow analysis system 1 performs processing of eliminating part of the obtained location information (cleansing processing). FIG. 5 is a diagram illustrating an overview of the cleansing processing.

As illustrated in FIG. 5, the location information on the user terminal 10 obtained by the positioning apparatus 81 includes noise. One reason for noise included in the location information is that, when the user terminal 10 is communicating, the user terminal 10 is selecting the positioning apparatus 81 with which it communicates. The user terminal 10 continuously searches for the positioning apparatus 81 that covers the area in which the user terminal 10 is located, and selects the positioning apparatus 81 that provides an optimal communication environment. Therefore, a position at a boundary between communication areas, or where multiple communication areas overlap, the positioning apparatus 81 may be frequently changed, causing noise in the location information. In addition, because the location information is estimated information as described above, the location information inevitably includes a certain degree of errors when the user terminal 10 is outside the communication area.

To address this, as illustrated in FIG. 5, the cleansing processing eliminates noise in the location information in a predetermined manner. By eliminating noise in the location information, the travel path of the user terminal 10 indicated by the location information is made accurate information. A specific manner of the cleansing processing will be described later.

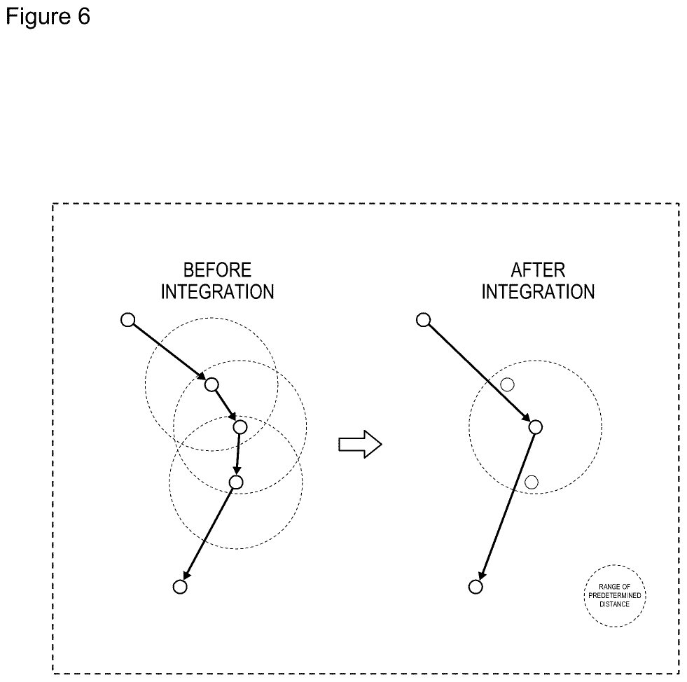

For the cleansed location information, the people-flow analysis system 1 generates trip data indicating the travel path. FIG. 6 is a diagram for describing the generation of the trip data.

As illustrated in FIG. 6, in generating the trip data, if the positioning apparatus 81 is unchanged (i.e., the location information indicates the same location) for more than a predetermined amount of time, the location is regarded as a staying-place candidate. The staying-place candidate is a location where the user is regarded as having stayed, irrespective of whether the user actually stayed there. Then, location information items that are sequential with the staying-place candidate and located within a predetermined distance from the staying-place candidate are integrated. In generating the trip data, the integrated location information and the time information are used to calculate a travel speed. This travel speed is used to determine the means of transportation, as described later.

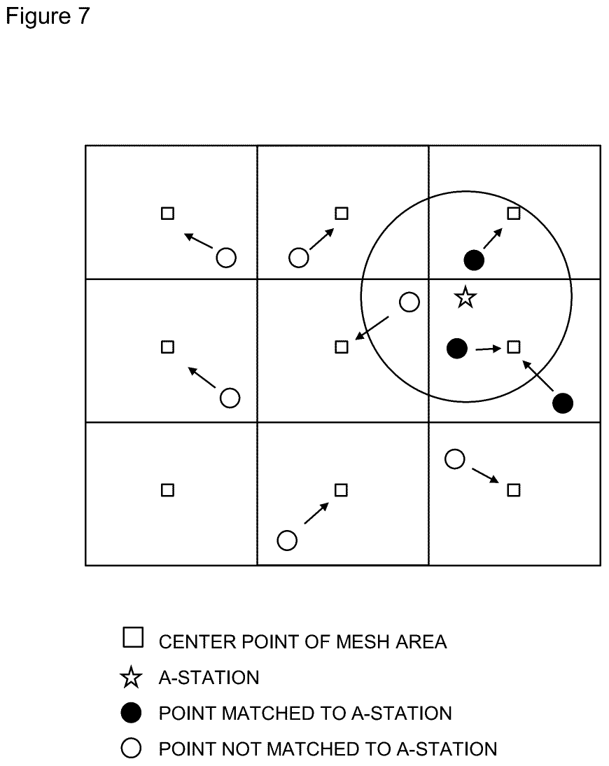

For the generated trip data, the people-flow analysis system 1 determines the means of transportation used in the travel path. FIG. 7 is a diagram for describing an overview of the determination of the means of transportation. As illustrated in FIG. 7, based on the location information, candidates for traffic base points are searched for. Here, traffic base points are matched to center coordinates of meshes. The matched traffic base points are stored as master data in association with their corresponding mesh codes. That is, traffic base points are searched for based on the mesh codes corresponding to the location information, rather than based on the coordinates of the location information. This can reduce a load of processing required for searching for traffic base points. From the candidates for traffic base points, the means of transportation is estimated.

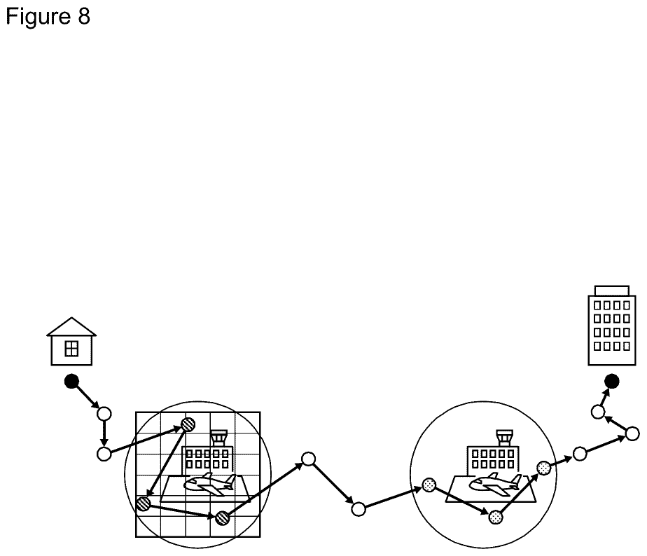

FIG. 8 is a diagram for describing processing performed if the means of transportation is determined to be aircraft in the determination of the means of transportation. As illustrated in FIG. 8, if the determination suggests aircraft based on the travel speed, the location information of the user terminal 10 is matched with the location information on airports. Flight service data is then queried based on the times in the location information, and if a relevant air route is identified, the use of aircraft is confirmed.

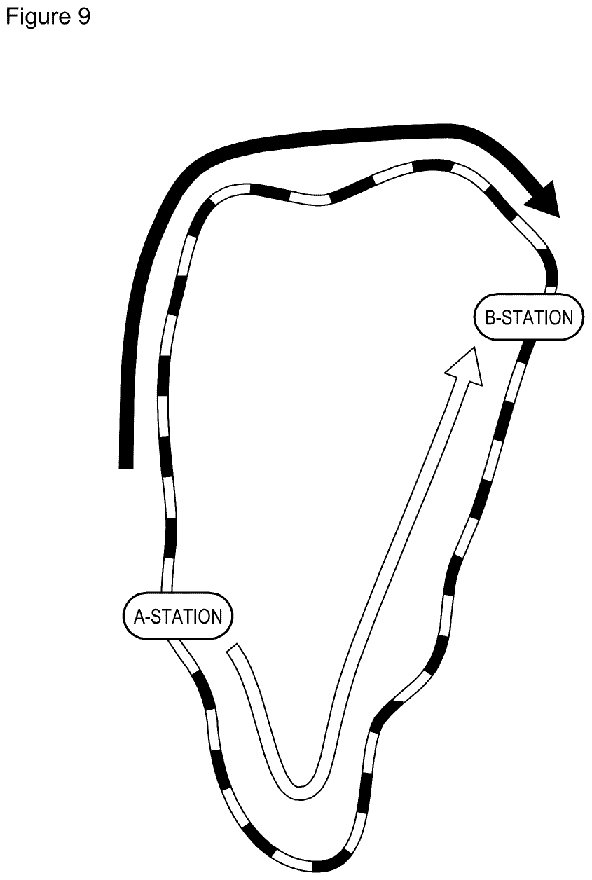

FIG. 9 is a diagram for describing processing performed if the means of transportation is determined to be railway or expressway in the determination of the means of transportation. As illustrated in FIG. 9, in this processing, routes between traffic base points included in the trip data are searched for to determine a used train route (or a road). Information on the used train routes and roads is stored in the traffic network database 30. In the case of this figure, the traffic network database 30 stores, as routes from an A-station to a B-station, two routes of a traffic network.

Thus, through the determination of the means of transportation, the people-flow analysis system 1 estimates, from changes in the location information, the selected means of transportation.

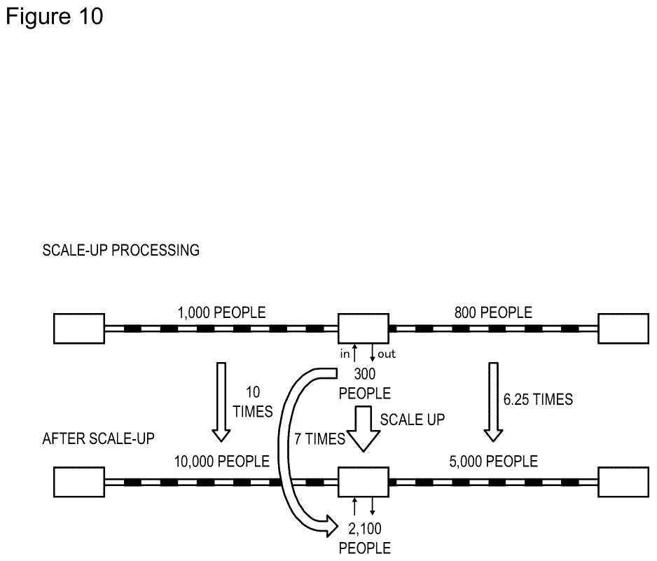

The people-flow analysis system 1 also performs processing of estimating the flows of people in the population of a target area in a statistical manner by scale-up estimation based on a penetration rate of the user terminals 10. In this processing, the number of samples (the number of user terminals 10 from which the location information was obtained) is scaled up to the population of the estimation area. FIG. 10 is a diagram for describing the scale-up processing. As illustrated in FIG. 10, a scale-up rate is set for each of traffic sections and traffic base points, and the number of samples is multiplied by the scale-up rate to estimate the flows of people in the area of interest. A specific flow of the above processing will be described below.

### (3) General Process

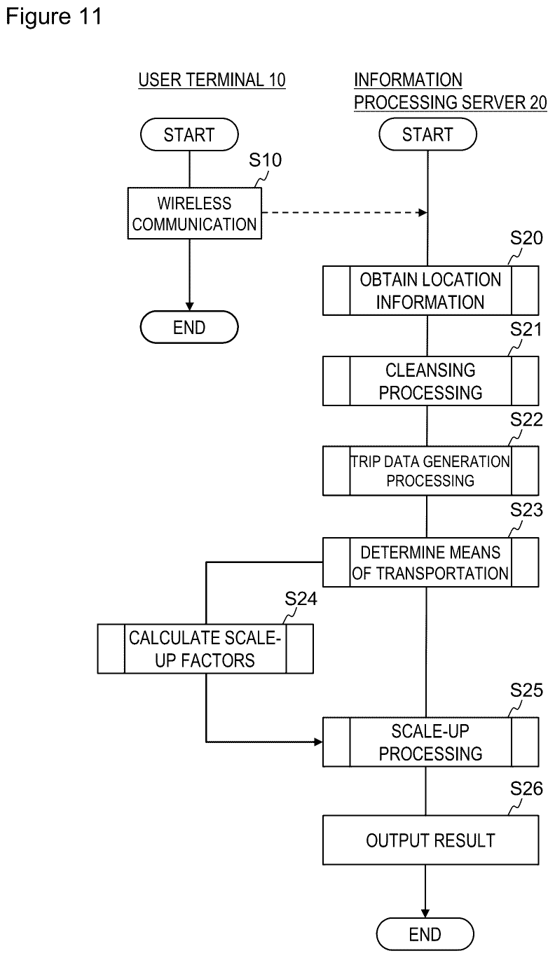

FIG. 11 is a flowchart illustrating a general process in the people-flow analysis system.

As illustrated in FIG. 11, in the people-flow analysis system 1, the user terminal 10 wirelessly communicates with the positioning apparatus 81 (step S10).

After step S10, the information processing server 20 reads location information accumulated in the location information database by the positioning apparatus 81 communicating with the user terminal 10 (step S20). Here, time information indicating the time of obtaining the location information is also read. Details of the manner of obtaining the location information will be described later.

After step S20, the information processing server 20 performs the cleansing processing on the location information (step S21). Details of the cleansing processing will be described later.

After step S21, the information processing server 20 generates trip data (step S22). Details of the manner of generating the trip data will be described later.

After step S22, the information processing server 20 determines the means of transportation included in the trip data (step S23). Details of the manner of determining the means of transportation will be described later.

After step S23, the information processing server 20 calculates scale-up factors (step S24). Details of the manner of calculating the scale-up factors will be described later. The processing of calculating the scale-up factors is performed periodically and may be skipped.

After step S24, the information processing server 20 performs scale-up processing using the scale-up factors (step S25). Details of the scale-up processing will be described later.

After step S25, the information processing server 20 outputs a result of the analysis (step S26). The manner of outputting the result of the analysis will be described later.

The general process in the people-flow analysis system thus terminates. Now, details of each processing step will be described.

### (3-1) Processing of Obtaining Location Information

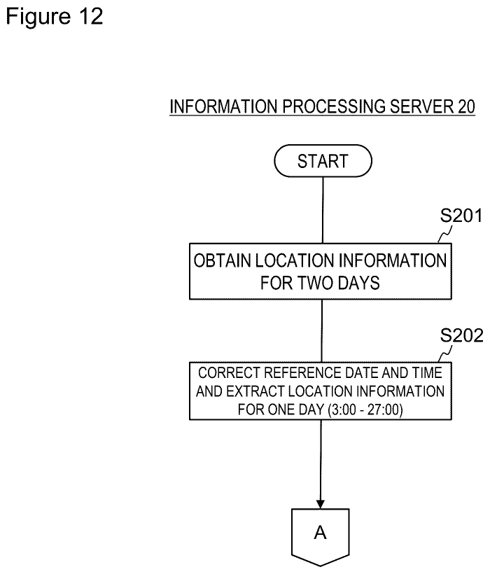

FIG. 12 is a flowchart illustrating the processing of obtaining the location information. As illustrated in FIG. 12, first, the information processing server 20 reads the location information on the user terminal 10 for two days from the location information database (step S201). Here, the information processing server 20 reads the location information for two days with reference to 0:00 a.m.

After step S201, the information processing server 20 corrects reference date and time (step S202). Specifically, the reference date and time is corrected so that one day corresponds to 24 hours from 03:00 a.m. to 27:00 in the next day. In this manner, the information processing server 20 sets different reference time periods for date and time of obtainment of the information and for date and time of evaluation of the information. This enables the flows of people who are active across 0:00 a.m. to be taken into the flows in one day.

After step S202, the information processing server 20 repeats the processing at step S202 for each user terminal 10 being used.

The processing of obtaining the location information thus terminates.

### (3-2) Cleansing Processing

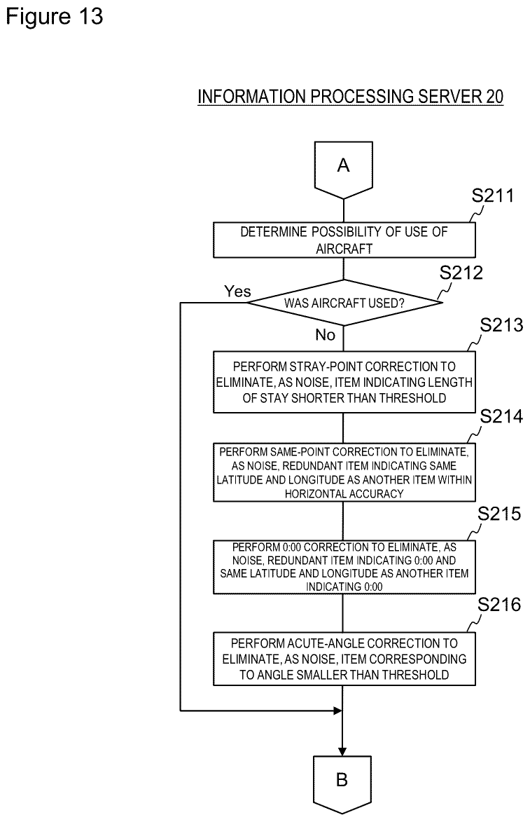

FIG. 13 is a flowchart illustrating the cleansing processing. As illustrated in FIG. 13, first, the information processing server 20 determines a possibility of the use of aircraft (step S211). This processing determines whether aircraft was used in the travel path based on factors such as the travel distance and the travel speed.

If it is determined at step S211 that there is the possibility of the use of aircraft (Yes at step S212), the information processing server 20 excludes the current location information item from the cleansing processing.

If it is determined at step S211 that there is no possibility of the use of aircraft (No at step S212), the information processing server 20 performs the cleansing processing.

After step S212, the information processing server 20 performs stray-point correction (step S213). The stray-point correction is processing of eliminating, as noise, a location information item indicating a length of stay shorter than a threshold.

After step S213, the information processing server 20 performs same-point correction (step S214). The same-point correction is processing as follows. If a location information item indicates substantially the same latitude and longitude as another item within a horizontal accuracy, which defines an allowable horizontal-distance error between locations in the location information, the item is regarded as redundant data and eliminated as noise.

After step S214, the information processing server 20 performs 0:00 correction (step S215). The 0:00 correction is processing as follows. If a location information item having the time information of 0:00 indicates the same latitude and longitude as another item having the time information of 0:00, the item is regarded as redundant data and eliminated as noise.

After step S215, the information processing server 20 performs acute-angle correction (step S216). The acute-angle correction is processing as follows. Displacement angles of location information items over time on a map are checked. If a displacement angle smaller than a predetermined threshold is detected, the location information item corresponding to a vertex of the displacement angle is eliminated as noise.

After step S216, the information processing server 20 repeats above steps S211 to S216 for each location information item. The cleansing processing thus terminates.

### (3-3) Processing of Generating Trip Data

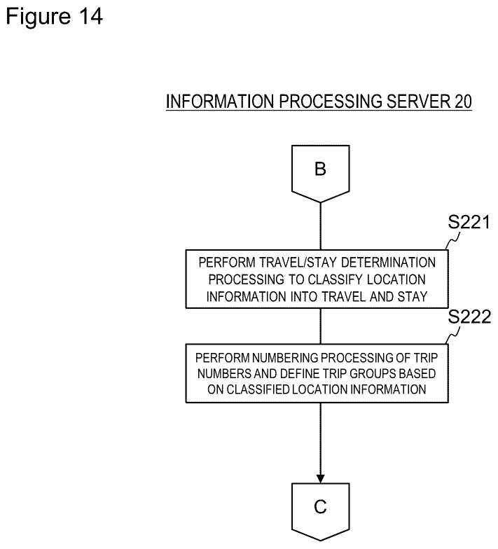

FIG. 14 is a flowchart illustrating the processing of the trip data. As illustrated in FIG. 14, in generating the trip data, the information processing server 20 makes a determination for classifying the cleansed location information into travel information and stay information (step S221).

Specifically, the result of the cleansing processing is read to obtain location information items on two sequential points (n, n+1) and determine a distance between the two points. If the distance between the two points is shorter than a threshold, the two points are put into a group n that originally includes n. If the distance between the two points is not shorter than the threshold, the two points are not put into the same group. This processing is repeated for each location information item.

A sum of the lengths of stay of the group n is then determined. If the total length of stay is shorter than a threshold, the location information items in the group n are determined to be travel.

If the total length of stay of the group is not shorter than the threshold, the longest length of stay is calculated among the lengths of stay of the location information items in the group.

If the calculated longest length of stay is shorter than a threshold, a distance between the location information items at the beginning and end in the group n is determined. If the calculated distance is shorter than a threshold, the group n is determined to be travel.

If the calculated distance is not shorter than the threshold, the group n is determined to be stay.

If the longest length of stay is not shorter than the threshold, the group n is determined to be stay.

The processing from the calculation of the total length of stay of the group n to the determination is repeated for each classified group.

After step S221, the information processing server 20 performs numbering processing (step S222). The numbering processing is processing of assigning numbers to the groups resulting from classifying the location information. Specifically, the location information items in the groups n and n+1 are obtained. A location information item having the longest length of stay in each group is set as a representative point. A distance between the representative points of the group n and the next group n+1 is calculated. If the calculated distance is not greater than a threshold and if the groups have been determined to be stay, the groups n and n+1 are defined as one trip group.

If the groups n and n+1 do not apply to the above case that the calculated distance is not greater than the threshold and the groups have been determined to be stay, the groups are defined as different trip groups.

For the defined trip group, a trip number and the total length of stay are set.

The processing from obtaining the location information items in the groups n and n+1 to setting the trip number and the total length of stay for the defined trip group is repeated for each classified group.

After step S222, the information processing server 20 repeats steps S221 to S222 for each user terminal 10 being used.

The processing of generating the trip data thus terminates.

### (3-4) Processing of Determining Means of Transportation

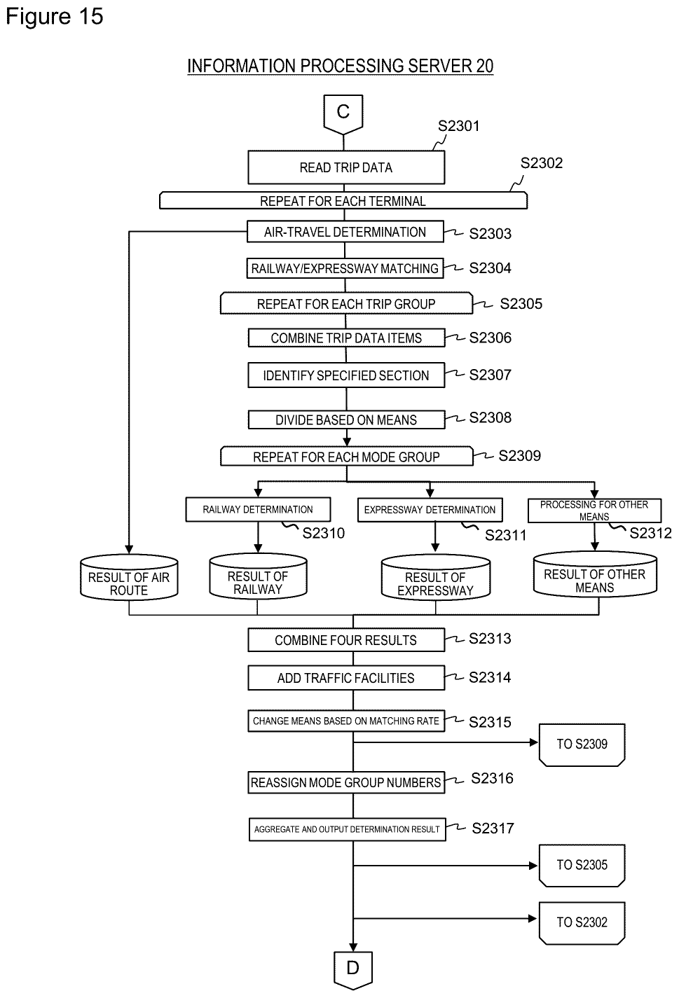

FIG. 15 is a flowchart illustrating the processing of determining the means of transportation. As illustrated in FIG. 15, in determining the means of transportation, the information processing server 20 reads the generated trip data (step S2301).

After step S2301, the information processing server 20 performs air-travel determination (step S2303). The air-travel determination is determination of whether the trip data includes travel by aircraft. The air-travel determination precedes determination of other means of transportation, because air travel is easily identified earlier due to the distinct speeds and routes of aircraft movements. Specifically, it is determined whether a base point to be a candidate for a departure airport is detected in any of the mesh areas including the location information in the trip data. If a base point to be the candidate for the departure airport is detected, it is determined whether a base point to be a candidate for an arrival airport is detected in any of the mesh areas including the location information in the trip data. If a base point to be the candidate for the arrival airport is detected, it is checked whether an air route connecting the candidates for the departure and arrival airports exists. Here, the time information in the location information is matched with flight service information. If such an air route exists, the trip data is determined to be air travel.

After step S2303, the information processing server 20 performs railway/expressway matching (step S2304). The railway/expressway matching is processing of matching the trip data with railway or expressway routes. Specifically, traffic section information and traffic facility information across the mesh areas where the location information is located are added to the data. From the mesh codes of the mesh areas where the location information is located and the horizontal accuracy, candidates for traffic facilities are searched for and added to the data. A result of adding the information on the traffic section candidates and the traffic facility candidates is then output.

After step S2304, the information processing server 20 combines trip data items (step S2306). Specifically, the data resulting from the railway/expressway matching processing is obtained to add start point information on a following trip data item to the end of a preceding trip data item. A result of combining the trip data items resulting from the matching processing is then output.

After step S2306, the information processing server 20 identifies a specified section (step S2307). The specified section is a section that meets predetermined conditions. Specifically, if a location information item in the trip data is within a specified section, it is determined that the trip data includes the specified section. A specified section is a section that tends to fail to secure a good communication environment, for example a subway line or a tunnel.

After step S2307, the information processing server 20 divides the trip data based on the means of transportation (step S2308). In dividing based on the means of transportation, travel means is set for the location information in the trip data. Each time the travel means is switched, a mode group number for distinguishing among travel means is set. The trip data is thus divided.

After step S2308, the information processing server 20 performs railway determination (step S2310). The railway determination is performed for, among the trip data items (mode groups) resulting from the dividing, the items for which the means of transportation has been determined to be railway. In the railway determination, railway route candidates are generated. For the current mode group, location information items indicating portions other than railway sections are deleted. Among the railway route candidates, a route with the lowest cost is selected and set as a transit link. From the travel time of the mode group, and the length of stay of the location information that uses the railway route selected as the transit link, a matching rate is calculated and set for the location information. Lastly, a result of setting the transit link and the matching rate is output.

After step S2308, the information processing server 20 performs expressway determination (step S2311). The expressway determination is performed for the mode groups for which the means of transportation has been determined to be expressway among the mode groups resulting from the dividing. In the expressway determination, expressway route candidates are generated. For the current mode group, location information items indicating portions other than expressway sections are deleted. Among the expressway route candidates, a route with the lowest cost is selected and set as a transit link. From the travel time of the mode group, and the length of stay of the location information that uses the expressway route selected as the transit link, a matching rate is calculated and set for the location information. Lastly, a result of setting the transit link and the matching rate is output.

After step S2308, the information processing server 20 performs processing for other means of transportation (step S2312). For a mode group identified as other means of transportation in the processing of dividing into means (step S2308), the processing for other means of transportation sets a departure facility, an arrival facility, a matching rate, and a route. Specifically, first, a mode group identified as other means of transportation is obtained. The lengths of stay in the location information, except the length of stay at the stay representative point, are summed to set information on the time taken by travelling by the other means of transportation. The location information items identified as the other means of transportation is organized into one record. A result of adding the information on the departure facility, the arrival facility, the matching rate, no route available, and the travel time is then output.

After the processing of the air-travel determination (step S2303), the railway determination (step S2310), the expressway determination (step S2311), and the other-means determination (step S2312), the information processing server 20 integrates the four results (step S2313).

After step S2313, the information processing server 20 adds traffic facilities (step S2314). Specifically, in the processing of adding traffic facilities, the integrated output result is obtained. Information on the facilities at the start and end points of the traffic section is added to the data. A result of adding the traffic facilities is then output.

After step S2314, the information processing server 20 changes the means of transportation based on the matching rate (step S2315). In the processing of changing the means of transportation, the means of transportation is changed if the matching does not satisfy conditions. Specifically, the means of transportation is changed for a mode group for which the transit link cannot be obtained, for which the matching rate cannot be obtained, or for which the matching rate is not higher than a threshold. Also, in the processing of changing the means of transportation, if a mode group for which the means has been determined to be railway or expressway has a matching rate lower than a threshold, the mode group is regarded as having no means of transportation identifiable and is deleted. Lastly, a result of the processing of changing the means of transportation is output.

The process then returns to step S2309, where the processing from the railway determination (step S2310), the expressway determination (step S2311), and the other-means determination (step S2312) to the means change (step S2315) is repeated for each mode group.

After step S2315, the information processing server 20 reassigns the mode group numbers (step S2316). In reassigning the mode group numbers, the mode groups identified as other means of transportation are integrated, and new mode group numbers are assigned. Specifically, the data resulting from changing the means of transportation is obtained to check whether mode groups of other means of transportation continue in the trip. If mode groups of other means of transportation continue, the mode groups are integrated, and a smaller mode group number is employed for the integrated mode group. Mode group numbers are then chronologically reassigned to the mode groups.

After step S2316, the determination result with the reassigned mode group numbers is output (step S2317). That is, the time, the start point facility, the end point facility, the mesh codes, and the length of stay are set for each renumbered mode group and output as a result of the means determination. Specifically, the result of renumbering is obtained, and for each mode group, the earliest time in the chronologically arranged time information is set for the mode group. The facility numbers at the start and end points and the corresponding mesh codes are obtained, and these information items are added to the mode group.

The lengths of stay of the mode group is summed, and information of the total length is added to the mode group. A record indicating these information items is generated, and a result is output. This processing is repeated for each mode group.

The process then returns to step S2305, where the processing from the combining of trip data items (step S2306) to the aggregation of the determination results (step S2317) is repeated for each trip group.

The process then returns to step S2302, where the processing from the air-travel determination (step S2303) to the aggregation of the determination results (step S2317) is repeated for each user terminal 10 being used. The processing of determining the means of transportation thus terminates.

### (3-5) Processing of Calculating Scale-Up Factors

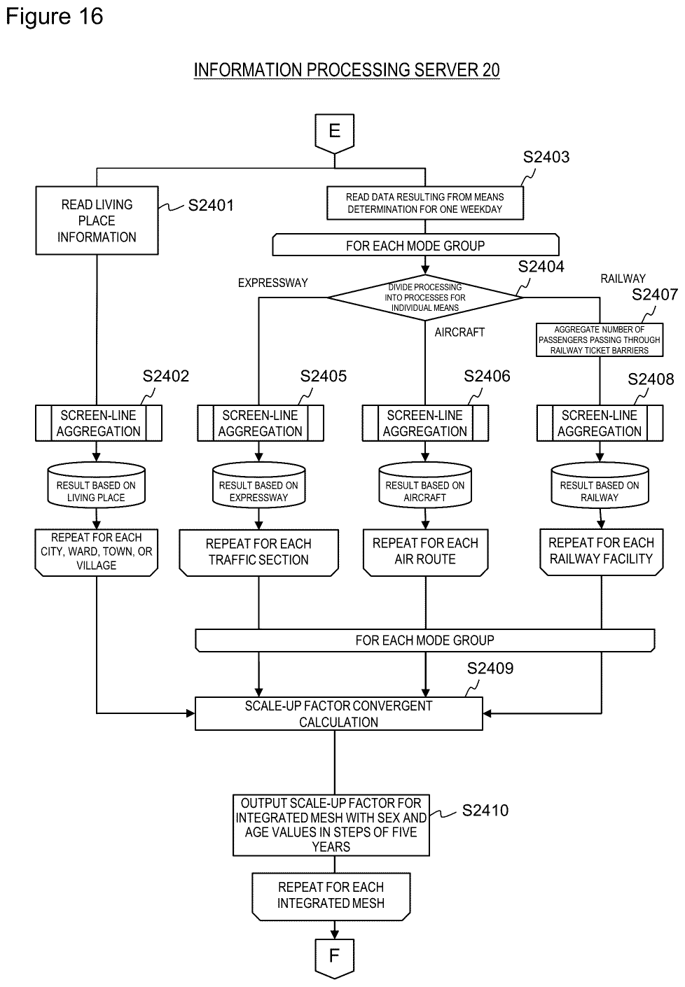

FIG. 16 is a flowchart illustrating the processing of calculating the scale-up factors. In the processing of calculating the scale-up factors, a scale-up factor for each integrated mesh of living places is calculated from the result of the means determination and is output. The processing of calculating the scale-up factors is performed at predetermined periods, and the same scale-up factors are used as master data throughout each predetermined period. An update period of the scale-up factors may be set as desired.

In the processing of calculating the scale-up factors, first, the information processing server 20 reads living place information on the users of the user terminals 10 (step S2401).

After step S2401, the information processing server 20 performs screen-line aggregation (step S2402). A screen line for a city, ward, town, or village is information indicating the living area (city, ward, town, or village) of people to be analyzed in people-flow analysis. Specifically, it represents the living place of the users of mobile terminals being used. In the screen-line aggregation for a city, ward, town, or village, municipal codes are set as screen lines, and the numbers of mobile terminal users living in the screen lines are calculated and output. Based on the mesh codes of living places, integrated mesh codes and population scale-up rates are added to the screen lines. The population scale-up rate is the population of an integrated mesh divided by the number of terminals being used in the integrated mesh.

For each screen line and for each integrated mesh code, the number of mobile phone terminals being used, in which the terminals' registered living place is the area of interest, is aggregated based on the location information. Results of aggregation not smaller than a threshold are output. The screen-line aggregation is repeated for each city, ward, town, or village. This is followed by scale-up factor convergent calculation (step S2409).

The information processing server 20 also reads the location information resulting from the means determination for one day (step S2403). The information processing server 20 divides processing into processes for the individual means of transportation (step S2404). First, screen-line aggregation is performed for the trip data in which the means of transportation is expressway (step S2405). A screen line for means of transportation is information representing the means of transportation for which people-flow analysis is to be performed. Specifically, it represents means of transportation included in the trip data. In the screen-line aggregation for the means of transportation, screen lines are set to correspond to expressway traffic sections, air routes, and railway facilities having ticket barriers to be passed through. The number of user terminals 10 that passed through each screen line is counted and output. In the current step, this processing is repeated for each traffic section. This is followed by the scale-up factor convergent calculation (step S2409).

Next, screen-line aggregation is performed for the trip data in which the means of transportation is aircraft (step S2406). This processing is repeated for each air route. This is followed by the scale-up factor convergent calculation (step S2409).

Next, if the means of transportation is railway, the number of passengers who passed through ticket barriers in a station is aggregated (step S2407). This processing is repeated for each railway section. Unlike in the case of expressways or air routes, if the means of transportation is railway, it is difficult to aggregate the amount of traffic (the number of people) within a section. Therefore, the screen-line aggregation is performed based on the number of people passing through ticket barriers. In this case, the ticket barriers in the first station in a used route are identified from a traffic section included in the trip data, and it is determined whether the route is a bullet train line or a conventional line. The number of people passing through the ticket barriers is aggregated for each mode group.

The screen lines are aggregated for the trip data in which the means of transportation is railway. This processing is repeated for each railway facility. This is followed by the scale-up factor convergent calculation (step S2409).

In the convergent calculation, a corrected scale-up rate (a scale-up factor) for each integrated mesh is calculated. This is done by correcting a population scale-up rate, which is a default value, using the number of users for each means of transportation and the number of residents in each city, ward, town, or village.

The means of transportation and the cities, wards, towns, and villages have priorities assigned according to the accuracy required for the screen lines.

For each integrated mesh, the number of users or residents multiplied by an uncorrected scale-up rate for the integrated mesh is calculated for each screen line, and this value is all added. The scaled-up number of users or residents for each screen line is thus calculated. This value is divided by a statistical value for the screen line to calculate a correction rate for the screen line.

According to the priorities assigned, the value of a combination of the number of residents and the correction rate is calculated. For example, this may be a weighted average of the numbers of users or residents in the screen lines having the same priority, and the correction rates for the screen lines. The calculated corrected scale-up rate is compared with an occupancy rate serving as a predetermined threshold. If the corrected scale-up rate exceeds the occupancy rate, this value is determined to be the corrected scale-up rate.

If the calculated corrected scale-up rate does not exceed the occupancy rate, the correction rate for each screen line is recalculated using the corrected scale-up rate just calculated. This is followed by calculating a weighted average of the numbers of users or residents in the screen lines having the next priority and the new correction rates for the screen lines. If the corrected scale-up rate newly calculated exceeds the occupancy rate, the corrected scale-up rate newly calculated is determined to be the corrected scale-up rate.

If the corrected scale-up rate newly calculated does not exceed the occupancy rate, the calculation of the corrected scale-up rate for the integrated mesh is repeated. The scale-up factor convergent calculation (step S2409) terminates when the corrected scale-up rate is determined for all the integrated mesh codes.

After step S2409, the information processing server 20 outputs the scale-up factor for the integrated mesh, along with sex and age values in steps of five years (step S2410). Outputting the scale-up factors is repeated for each integrated mesh.

The processing of generating the scale-up factors thus terminates.

In the processing of generating the scale-up factors, the scale-up factor convergent calculation may be performed based on only the result of aggregating the screen lines for the means of transportation, without aggregating the screen lines for the living places.

### (3-5) Scale-Up Processing

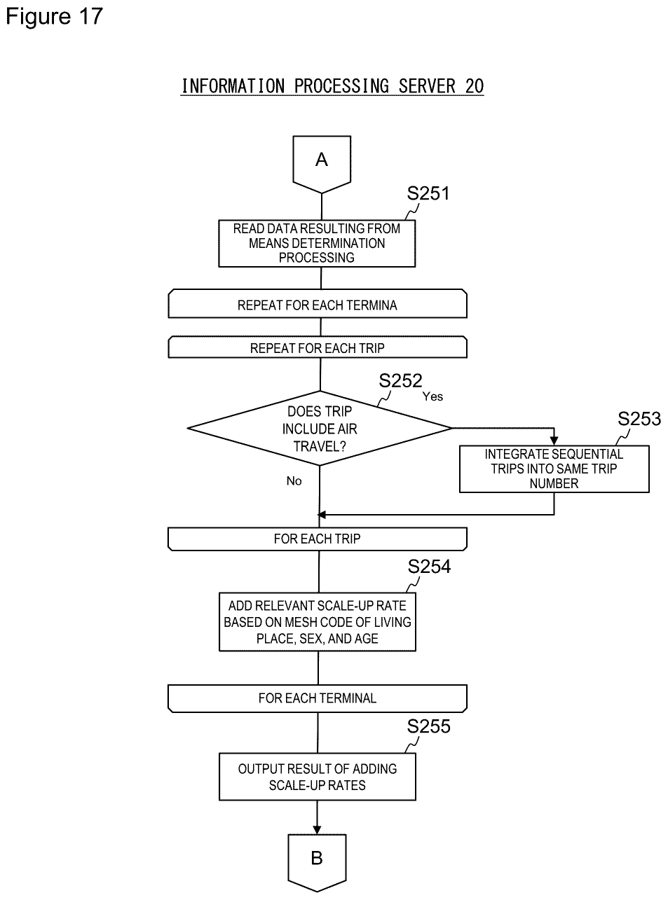

FIG. 17 is a flowchart illustrating the scale-up processing. As illustrated in FIG. 17, in the scale-up processing, the information processing server 20 reads the trip data resulting from the processing of determining the means (step S251).

After step S251, the information processing server 20 determines whether the trip data includes air travel (step S252).

If the trip data includes air travel (Yes at step S252), sequential trips are integrated into the same trip number (step S253).

If the trip data does not include air travel (No at step S252), the trip numbers are not changed. The processing at steps S252 and S253 is repeated for each trip data item.

After steps S252 and S253, the information processing server 20 adds a relevant scale-up rate to the data based on the mesh code of the living place, sex, and age (step S254). The processing at steps S252 to S254 is repeated for each terminal being used.

After step S254, the information processing server 20 outputs a result of adding the scale-up rates.

The scale-up processing thus terminates.

Thereafter, scaled-up estimated statistical people-flow data can be generated by multiplying the result of determining the means of transportation by the calculated scale-up factor.

### (4) Advantageous Effects

As described above, according to the people-flow analysis system 1, an accumulated history of location information on user terminals are aggregated to detect the users' travel paths, thereby analyzing people-flow data. Aggregating the history of actual observed location information enables analyzing highly accurate people-flow data.

According to the people-flow analysis system 1, the cleansing processing is performed on the location information on the obtained user terminals 10. Thus, if the location information includes certain degree of errors in the location accuracy, part of the location information acting as noise is eliminated according to predetermined rules. This can ensure the location accuracy.

Because the cleansing processing thins out the location information, the people-flow data can be analyzed without too much load of processing for the people-flow data analysis.

According to the people-flow analysis system 1, the means of transportation are determined for the generated trip data. Thus, not only the travel paths but also the travel means can be determined. This enables obtaining information about which means of transportation are used and how the means are used.

According to the people-flow analysis system 1, scale-up factors are calculated to perform scale-up estimation for the population of an estimation area. This enables obtaining approximate statistical flows of people in the population of the estimation area, without being limited to the number of user terminals 10 being used.

### (5) Variation

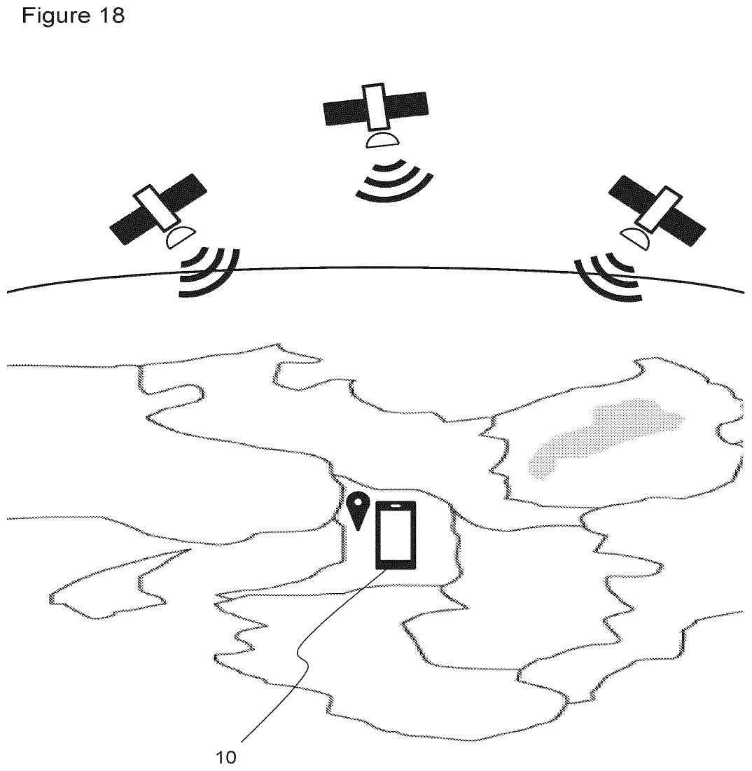

Now, a variation of the positioning apparatus 81 will be described. FIG. 18 is a diagram illustrating a variation of the positioning apparatus 81. In this variation, a configuration in which the positioning apparatus 81 is a mobile positioning apparatus will be described.

As illustrated in FIG. 18, the positioning apparatus 81 according to the variation adopts a GPS system in which the apparatus serves as a mobile positioning apparatus that communicates with communication apparatuses while moving. The mobile positioning apparatus may adopt various positioning systems, not limited to GPS systems, in which the apparatus communicates with communication apparatuses while moving and obtains location information on the user terminals 10 that are communication apparatuses.

Examples of other systems of mobile positioning apparatuses may include global navigation satellite systems (GNSSs) other than GPSs, and regional navigation satellite systems (RNSSs).

In the example shown, a user terminal 10 communicates with multiple GPS satellites, so that the GPS system identifies the location information on the user terminal 10. The location information on the identified user terminal 10 is accumulated in a location information database. The GPS system continuously obtains the location information at predetermined sampling periods and accumulates the location information in the location information database.

The location information on the user terminal 10 accumulated in the location information database is used in the above-described processing at step S20 and subsequent steps illustrated in FIG. 11.

The people-flow analysis system 1 does not necessarily need to perform the processing of estimating the scale-up factors.

For example, if the GPS system as illustrated in the variation is used to obtain the location information, it is conventionally difficult to secure a sufficient number of samples of location information (a sufficient number of user terminals 10). As such, estimating the scale-up factors and performing the scale-up processing might not ensure the accuracy. For this reason, especially when mobile positioning apparatuses are used to obtain the location information on the user terminals 10, estimation of the scale-up factors may be avoided.

While a preferred embodiment of the present disclosure has been described above, the present disclosure is not limited to the above specific embodiment but encompasses aspects of the invention set forth in the claims and their equivalents. The configurations of the apparatuses described in the above embodiment and variation may be combined as appropriate as long as they do not cause technical inconsistency.

The program of the present invention may be expressed by multiple pieces of source code, and the system 1 of the present invention may be implemented by multiple hardware resources.

What is claimed is:

1. A people-flow analysis apparatus that analyzes people-flow data using location information from mobile terminals, comprising:
processing circuitry configured to:
read, along with time information, location information estimated based on communication performed by a plurality of mobile terminals with a positioning apparatus, from a database in which the location information is accumulated;
perform cleansing processing for thinning out, according to a predetermined rule, the location information received by the positioning apparatus;
generate, for the cleansed location information, trip data indicating travel paths of users carrying the mobile terminals; and
determine, for the generated trip data, means of transportation of the users.

2. The apparatus according to claim 1, the processing circuitry further configured to:
calculate, for performing scale-up estimation from a number of samples of the location information to a population of an estimation area, a scale-up factor for scaling up a number of mobile terminals being used to the population of the estimation area.

3. The apparatus according to claim 1, wherein in reading the location information, the processing circuitry configured to
set different reference time periods for date and time of obtainment of the location information and for date and time of evaluation of the location information.

4. The apparatus according to claim 1, wherein in performing the cleansing processing, the processing circuitry configured to
perform processing of eliminating a location information item indicating a location identical with a location of another location information item.

5. The apparatus according to claim 1, wherein in performing the cleansing processing, the processing circuitry configured to
perform processing of checking displacement angles of the location information over time on a map, and if a displacement angle smaller than a predetermined threshold is detected, eliminating a location information item corresponding to a vertex of the displacement angle.

6. The apparatus according to claim 1, wherein in performing the cleansing processing,
the processing circuitry configured to
perform processing of eliminating a location information item indicating a length of stay in a predetermined area shorter than a predetermined threshold.

7. The apparatus according to claim 1, wherein in performing the cleansing processing, the processing circuitry configured to
calculate a travel speed from an amount of displacement of the location information over time, and excluding, from thinning-out processing, a location information item indicating displacement at a speed higher than a predetermined speed.

8. The apparatus according to claim 1, wherein in generating the trip data, the processing circuitry configured to
calculate an amount of displacement of the location information over time and classifying a location information item as stay or travel.

9. The apparatus according to claim 1, wherein in generating the trip data, the processing circuitry configured to
integrate the location data items into a single trip data item if sequential location data items are apart by a distance not longer than a threshold and are classified as stay.

10. The apparatus according to claim 1, wherein in determining the means of transportation of the users, the processing circuitry configured to
determine air travel based on the location information before determining other means of transportation.

11. The apparatus according to claim 1, wherein in determining the means of transportation of the users, the processing circuitry configured to
determine the means of transportation after adding traffic section information and traffic facility information to the location information.

12. The apparatus according to claim 1, wherein in determining the means of transportation of the users, the processing circuitry configured to:
set, for each trip data item, a start and a goal for each of a plurality of travel means;
identify a plurality of routes allowing travel from the start to the goal at a travel speed of the travel means; and
determine means of transportation based on a matching rate with a lowest-cost route among the plurality of identified routes.

13. The apparatus according to claim 1, wherein the processing circuitry further configured to
using master data that stores traffic base points and associated partitioned areas corresponding to predetermined regions, estimate a candidate for a used traffic base point by searching, based on the location information, the partitioned areas associated with the traffic base points.

14. The apparatus according to claim 2, wherein in calculating the scale-up factor the processing circuitry
Calculate a scale-up factor for each integrated area resulting from integrating unit areas preset in a predetermined size, and for each determined means of transportation.

15. The apparatus according to claim 2, wherein in calculating the scale-up factor, the processing circuitry
calculate a corrected factor for each integrated partitioned area based on a number of traffic-facility users and a corrected number of users.

16. The apparatus according to claim 2, wherein in calculating the scale-up factor, the processing circuitry
set a screen line for each of municipal codes, expressway traffic sections, air routes, and railway facilities having ticket barriers to be passed through, the screen line indicating a boundary expected to be passed through by travel means; and calculating, for each travel means, a screen line passing count that indicates a number of times the screen line is passed through.

17. A people-flow analysis method that analyzes people-flow data using location information from mobile terminals, the method to be executed by a computer including a processing circuitry, the method causing the processing circuitry to perform to:
read, along with time information, location information estimated based on communication performed by a plurality of mobile terminals with a positioning apparatus;
perform cleansing processing for thinning out, according to a predetermined rule, the location information received by the positioning apparatus;
generate, for the cleansed location information, trip data indicating travel paths of users carrying the mobile terminals; and
determine, for the generated trip data, means of transportation of the users.

18. A people-flow analysis system that comprises a processor of a computer and analyzes people-flow data using location information from mobile terminals, the processor of the computer comprising:
a module that reads, along with time information, location information estimated based on communication performed by a plurality of mobile terminals with a positioning apparatus;
a module that performs cleansing processing for thinning out, according to a predetermined rule, the location information received by the positioning apparatus;
a module that generates, for the cleansed location information, trip data indicating travel paths of users carrying the mobile terminals; and
a module that determines, for the generated trip data, means of transportation of the users.
